(19) United States
(12) Patent Application Publication
(10) Pub. No.: US 2010/0245916 A1
(43) Pub. Date: Sep. 30, 2010

(54) IMAGE PROCESSING APPARATUS AND ITS IMAGE PROCESSING METHOD

(75) Inventor: Teruyuki FUKAYA, Fukuoka (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/749,801

(22) Filed: Mar. 30, 2010

(30) Foreign Application Priority Data
Mar. 31, 2009 (JP) 2009-084601

(51) Int. Cl. G06F 15/00

(52) U.S. Cl. 358/1.16

(57) ABSTRACT

A scanner is equipped with an input image buffering section 13 for storing read-out image data; a storage managing section 11 for managing the image data in the form of processing blocks that are arranged in the vertical direction and the horizontal direction; a block data reading section 14 for reading, as processing subject blocks, processing blocks each of which overlaps with a divisional cuffing-out block of a document image which is inclined with respect to the image data by a certain angle, from the input image buffering section 13 for each band of processing blocks arranged in the auxiliary scanning direction; and a block rotating section 15 for rotating the processing subject blocks while maintaining positional relationships between them, and storing rotated processing subject blocks in a rotated image buffering section which has a capacity corresponding to three processing blocks for each band of processing blocks arranged in the auxiliary scanning direction.

### BACKGROUND

1. Field of the Invention

The present invention relates to an image processing apparatus that reads a document image with an image sensor and storing resulting image data in a storage section, as well as to its image processing method.

2. Description of the Related Art

When plural pages of a document are supplied to a reading device with an automatic sheet feeder and read by the reading device, there may occur an event that a document page is supplied to the reading device obliquely. In this case, a document image portion contained in image data obtained by reading such a document page is inclined and hence it is necessary to perform a correction of rotating the document image portion into a non-inclined one.

Where the maximum readable document size of a reading device is the A3 size and a document to be read has the A4 size, document pages can be read irrespective of whether they are oriented vertically or horizontally. In such a case, it may be necessary to rotate image data obtained by reading each document page from horizontal orientation to vertical orientation or vice versa.

The reading device sequentially produces image data of the lines of the whole of each document page by moving the document page or a line image sensor in the auxiliary scanning direction every time one line of the document page is read with the line image sensor in the main scanning direction, and hence image data of the lines are stored in an image memory sequentially.

An image processing apparatus of the above kind capable of rotating image data is known which is disclosed in Patent document 1. An image communication apparatus disclosed in Patent document 1 is such that a facsimile function is added to a printing apparatus such as a laser beam printer. In this image communication apparatus, if A4 printing sheets are oriented horizontally when it is attempted to print received A4 image data that is oriented vertically, image data of each page (A4 vertical) is divided into plural blocks and image data of the plural blocks are rotated so as to conform to respective A4-horizontal divisional blocks (target blocks) and printed sequentially. As a result, processing of rotating the entire image data of each page is not necessary and the necessary memory capacity can be reduced.

Patent document 1: JP-A-9-214745

The image communication apparatus disclosed in Patent document 1 merely rotate each page of an A4 document by 90° from vertical orientation to horizontal orientation. Therefore, target blocks can be divisional bands of an A4-horizontal area.

However, the image processing method of the image communication apparatus disclosed in Patent document 1 cannot accommodate a case of rotating image data that is inclined by an arbitrary angle other than 90°, 180°, and 270° with respect to a reference direction.

In rotating image data of each document page by an arbitrary angle, an image processing apparatus can be reduced in size or cost if the necessary buffer capacity is minimized.

### SUMMARY

An object of the present invention is therefore to provide an image processing apparatus and its image processing method that can reduce the buffer capacity which is necessary in rotating image data by an arbitrary angle.

An image processing apparatus according to the invention is characterized by comprising storage section for storing image data; storage managing section for managing the image data in the form of plural processing blocks that are arranged in a vertical direction and a horizontal direction, and storing at least part of the processing blocks in the storage section in such a manner that each processing block is accessible; block data reading section for reading, as processing subject blocks, processing blocks that overlap with a rectangular area inclined with respect to the image data by a certain angle and in which at most three processing blocks are arranged in a reference direction which is a vertical direction or a horizontal direction, from the storage section for each band of processing blocks arranged in the reference direction; rotated image buffering section for storing the read-out processing subject blocks, the rotated image buffering section having a capacity corresponding to three processing blocks for each band of processing blocks arranged in the reference direction; and block rotating section for rotating the processing subject blocks that are read out by the block data reading section by a specified angle while maintaining positional relationships between the processing subject blocks, and storing rotated processing subject blocks in the rotated image buffering section.

According to the invention, it suffices that the rotated image buffering section for storing processing blocks to perform rotation has a capacity that corresponds to three processing blocks E for each band, extending in the reference direction, of image data. Therefore, the necessary buffer capacity can be minimized. That is, the invention can save the memory capacity that is required in rotating image data by an arbitrary angle.

A first aspect of the invention provides an image processing apparatus comprising a storage section for storing image data; a storage managing section for managing the image data in the form of plural processing blocks that are arranged in a vertical direction and a horizontal direction, and storing at least part of the processing blocks in the storage section in such a manner that each processing block is accessible; a block data reading section for reading, as processing subject blocks, processing blocks that overlap with a rectangular area inclined with respect to the image data by a certain angle and in which at most three processing blocks are arranged in a reference direction which is a vertical direction or a horizontal direction, from the storage section for each band of processing blocks arranged in the reference direction; a rotated image buffering section for storing the read-out processing subject blocks, the rotated image buffering section having a capacity corresponding to three processing blocks for each band of processing blocks arranged in the reference direction; and a block rotating section for rotating the processing subject blocks that are read out by the block data reading section by a specified angle while maintaining positional relationships between the processing subject blocks, and storing rotated processing subject blocks in the rotated image buffering section. In this aspect of the invention, to cut out and rotate back a rectangular area that is inclined with respect to the area of image data by a certain angle, the block data reading section reads out, as processing subject blocks, for each band of processing blocks arranged in the reference direction, processing blocks that overlap with the inclined rectangular area and in which at most three processing blocks are arranged in the reference direction. As a result, the rotation processing can be performed by processing a smallest amount of data. It suffices that the rotated image buffering section for storing processing blocks to perform rotation has a capacity that corresponds to three processing blocks for each band, extending in the reference direction. Therefore, the necessary buffer capacity can be minimized.

A second aspect of the invention provides an image processing apparatus which further comprises a cutting-out area processing section for dividing the rectangular area into cutting-out blocks that are arranged in two orthogonal directions when a width of the rectangular area is greater than a prescribed value, and in which the block data reading section sequentially reads sets of processing subject blocks that overlap with respective band-shaped cutting-out blocks each extending in one of the two orthogonal directions. According to this aspect of the invention, since the cutting-out area into cutting out blocks that are arranged in the two orthogonal directions, data rotation can be performed without increasing the capacity of the rotated image buffering section even in the case where the width of the rectangular area is greater than the prescribed value.

A third aspect of the invention provides an image processing apparatus wherein the cutting-out area processing section sets the length of shorter sides of each of the band-shaped cutting-out blocks shorter than or equal to \sqrt{2} times a length of each side of each of the processing blocks which are square. According to this aspect of the invention, for the following reason, the number of processing subject blocks that overlap with each band-shaped cutting-out block can be made smaller than or equal to three. The area of overlap between a processing block and a band-shaped cutting-out block is largest when the two longer sides of the band-shaped cutting-out block pass respective diagonal apices of the processing block. In this case, the band-shaped cutting-out block inclined with respect to the processing block E by 45°. If the length of the shorter sides of each band-shaped cutting-out block is set \sqrt{2} times the length of each side of each processing block E, the band-shaped cutting-out blocks become rectangles whose width is equal to the diagonal length of each processing block. Therefore, the band-shaped cutting-out block overlaps with three processing blocks in total, that is, the middle processing block and the two processing block located on both sides of the middle processing block. Therefore, the cutting-out area R can be rotated using a minimum-capacity storage area if the rotated image buffering section 16 is provided with a storage capacity that corresponds to three processing blocks F. In conclusion, a cut-out rectangular area can be rotated with a minimum storage capacity by forming the rotated image buffering section so that it has a capacity corresponding to three processing blocks for each band, extending in the reference direction, of image data.

A fourth aspect of the invention provides an image processing apparatus wherein the block rotating section performs a combination of a rotation of 90°, 180°, or 270° and a rotation of an angle that is larger than 0° and smaller than or equal to 45° on the rectangular area when an angle formed by a longitudinal direction of the rectangular area and the reference direction which is an inclination angle of the rectangular area is larger than 45°. According to this aspect of the invention, since a combination of a rotation of 90°, 180°, or 270° and a rotation of an angle that is larger than 0° and smaller than or equal to 45° is performed on the rectangular area when the angle formed by the longitudinal direction of the rectangular area and the reference direction which is an inclination angle of the rectangular area is larger than 45°, the rectangular area can be rotated by an arbitrary angle from 0° to 360°.

A fifth aspect of the invention provides an image processing method which is characterized by comprising a storage managing step of managing image data in the form of plural processing blocks that are arranged in a vertical direction and a horizontal direction, and storing at least part of the processing blocks in storage section in such a manner that each processing block is accessible; a block data reading step of reading, as processing subject blocks, processing blocks that overlap with a rectangular area inclined with respect to the image data by a certain angle and in which at most three processing blocks are arranged in a reference direction which is a vertical direction or a horizontal direction, from the storage section for each band of processing blocks arranged in the reference direction; and a block rotating step of rotating the read-out processing subject blocks by a specified angle while maintaining positional relationships between the processing subject blocks, and storing rotated processing subject blocks in a rotated image buffering section for storing the read-out processing subject blocks which has a capacity corresponding to three processing blocks for each band of processing blocks arranged in the reference direction. In this aspect of the invention, to cut out and rotate back a rectangular area that is inclined with respect to the area of image data by a certain angle, processing blocks that overlap with the inclined rectangular area and in which at most three processing blocks are arranged in the reference direction are read out as processing subject blocks for each band of processing blocks arranged in the reference direction. As a result, the rotation processing can be performed by processing a smallest amount of data. It suffices that the rotated image buffering section for storing processing blocks to perform rotation has a capacity that corresponds to three processing blocks for each band extending in the reference direction. Therefore, the necessary buffer capacity can be minimized.

### BRIEF DESCRIPTION OF THE DRAWINGS

FIG. 1 is a block diagram showing the configuration of an image processing apparatus according to an embodiment of the present invention.

FIG. 2 illustrates the structure of image data to be produced by the image processing apparatus according to the embodiment of the invention.

FIG. 3 shows a management table of the image processing apparatus according to the embodiment of the invention.

FIG. 4 shows a positional relationship between a cutting-out area and image data that is managed by using the management table in the image processing apparatus according to the embodiment of the invention.

FIG. 5 is a flowchart for description of an operation of the image processing apparatus according to the embodiment of the invention.

FIG. 6 shows processing subject blocks in the management table of the image processing apparatus according to the embodiment of the invention.

FIG. 7 shows relationships between band-shaped cutting-out blocks and processing subject blocks in the image processing apparatus according to the embodiment of the invention.

FIG. 8 illustrates an operation of a block rotating section of the image processing apparatus according to the embodiment of the invention.

FIG. 9 illustrates an operation of a rotated image buffering section of the image processing apparatus according to the embodiment of the invention.

FIG. 10 illustrates pixel interpolation processing of the image processing apparatus according to the embodiment of the invention.

FIG. 11 illustrates a subsequent operation of the rotated image buffering section of the image processing apparatus according to the embodiment of the invention.

### DETAILED DESCRIPTION

### Embodiment

An image processing apparatus and its image processing method according to an embodiment of the invention will be hereinafter described with reference to the drawings using a scanner as an example.

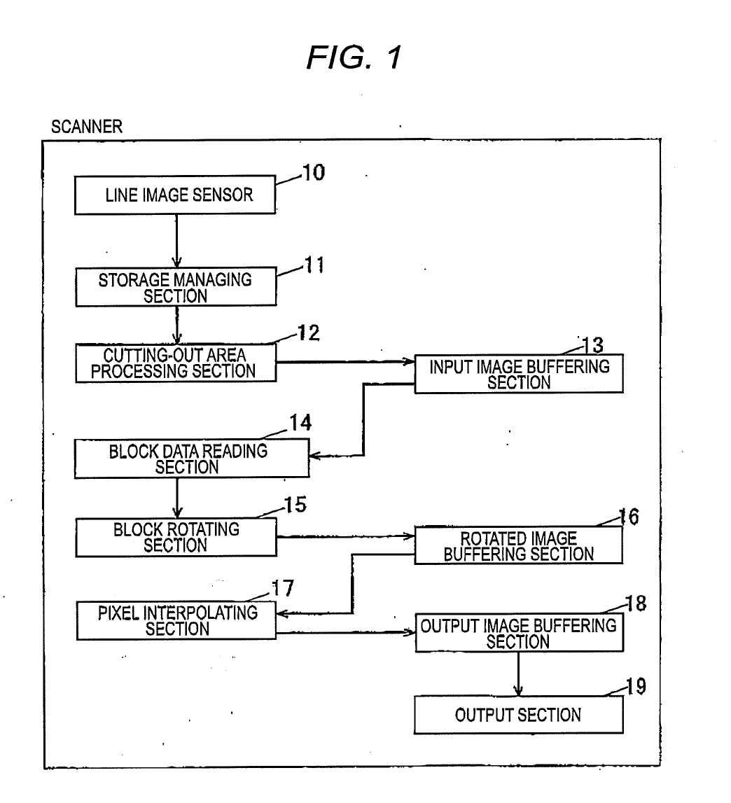

FIG. 1 is a block diagram showing the configuration of the image processing apparatus according to the embodiment of the invention.

As shown in FIG. 1, the scanner according to the embodiment of the invention is provided with a line image sensor 10, a storage managing section 11, a cutting-out area processing section 12, a input image buffering section 13, a block data reading section 14, a block rotating section 15, a rotated image buffering section 16, a pixel interpolating section 17, an output image buffering section 18, and an output section 19.

Being a general solid-state imaging device such as an optical reduction type CCD (charge-coupled device) or a contact sensor type CIS (contact image sensor), the line image sensor 10 can read a document image in full-color in the main scanning direction in units of a prescribed number of lines.

Where the scanner is of a flat bed type, a document is placed on a transparent platen and a document image is read as the line image sensor 10 is moved under the platen in the auxiliary scanning direction.

Where the scanner is of a sheet feed type, the line image sensor 10 is fixed at a position that is close to a reading position on a platen and a document is moved in the auxiliary scanning direction by transport rollers (not shown). The line image sensor 10 reads a moving document image in the main scanning direction in units of a prescribed number of lines.

In the embodiment, the line image sensor 10 reads a document image in the main scanning direction on a line-by-line basis. Alternatively, the scanner may be configured in such a manner that a document image is read in units of plural lines (e.g., four lines).

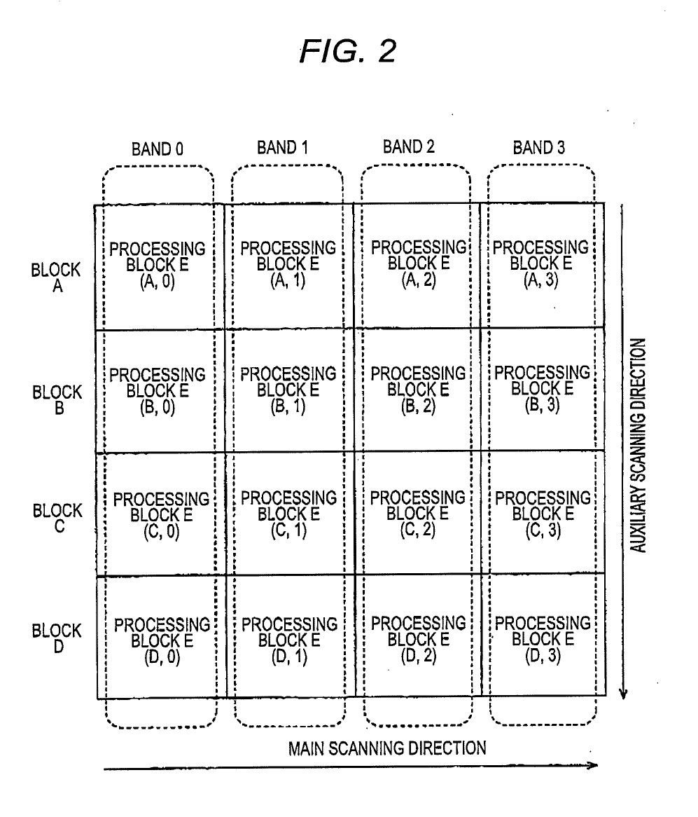

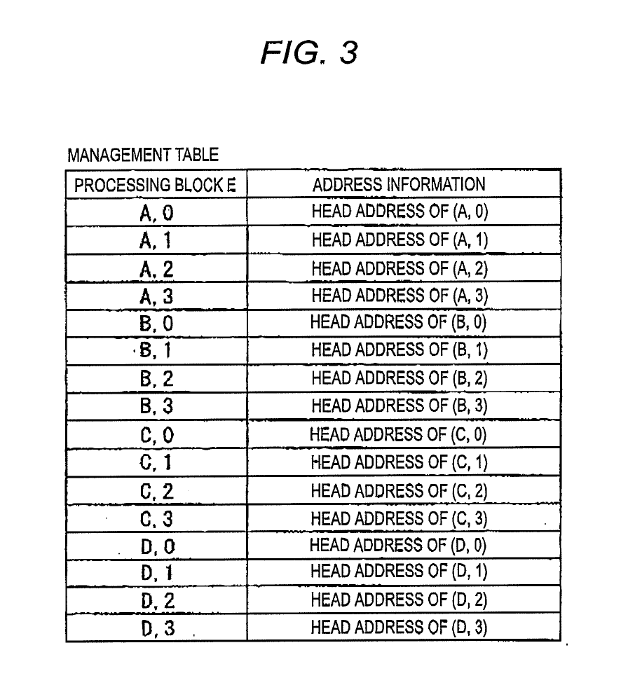

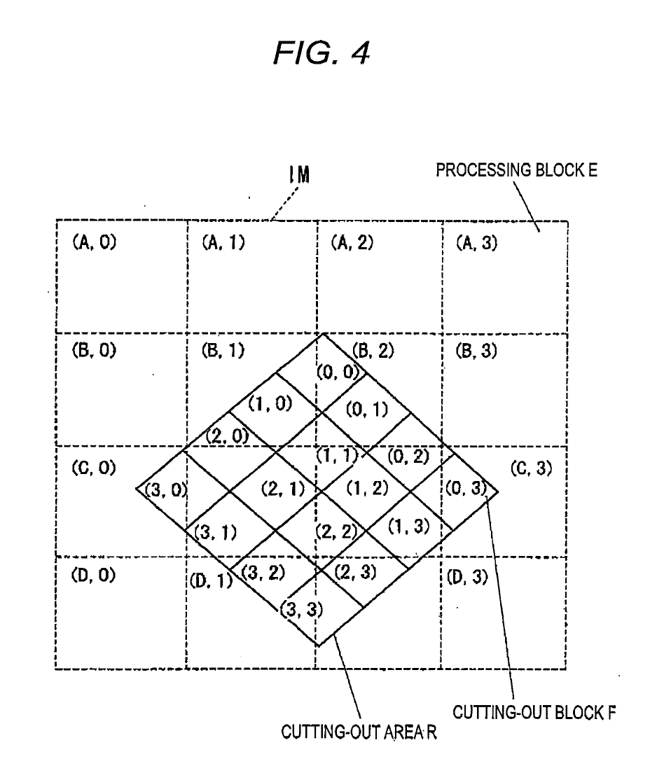

As shown in FIG. 2, the storage managing section 11 manages image data IM (see FIG. 4) produced by the line image sensor 10 as data of polygonal divisional processing blocks E (typified by squares that are arranged in the vertical direction and the horizontal direction). As shown in FIG. 3, the storage managing section 11 sets a management table for management of the processing blocks E. A managing method of the image data IM will be described below in detail with reference to FIG. 2.

FIG. 2 illustrates the structure of image data IM to be produced by the image processing apparatus according to the embodiment of the invention. In the example of FIG. 2, the processing blocks E are defined as regions that are obtained by dividing the image data IM into four bands 0-3 in the main scanning direction and dividing each of the bands 0-3 into regions having a prescribed number of pixels in the auxiliary scanning direction. The blocks E are square because they have the same number of pixels in the main scanning direction and the auxiliary scanning direction.

More specifically, in the example of FIG. 2, the image data IM, which is document readout data of a reading area produced by the line image sensor 10, is divided into 16 (4×4) processing blocks E. The processing blocks E (A, 0) to (D, 3) are minimum management units of the image data IM. The image data IM has an area that is large enough to accommodate the entire readout data of a document even if the document is read by the line image sensor 10 being inclined in any direction.

FIG. 3 shows a management table of the image processing apparatus according to the embodiment of the invention. As shown in FIG. 3, the storage managing section 11 shown in FIG. 1 has a management table in which pieces of information which is at least the same in number as the processing blocks E of FIG. 2 can be arranged. Pieces of address information indicating head addresses of the processing blocks E, respectively, are set and stored in the management table.

FIG. 4 shows a positional relationship between a cutting-out area and image data that is managed by using the management table in the image processing apparatus according to the embodiment of the invention.

The cutting-out area processing section 12 shown in FIG. 1 defines a cutting-out area R that contains readout data of a document which is within the area of image data IM (see FIG. 4) and recognizes a vertical length and a horizontal length of the document and a position and a direction of the readout data of the document in the area of the image data IM. Furthermore, the cutting-out area processing section 12 recognizes processing blocks E each of which contains part of the readout data of the document and requires rotation processing among the processing blocks E (A, 0) to (D, 3), performs processing of dividing the cutting-out area R into 16 cutting-out blocks F which are arranged in the vertical direction and the horizontal direction, and stores the blocks E that have been recognized as requiring rotation processing in the input image buffering section 13.

The cutting-out blocks F will be described below. As shown in FIG. 4, when a document is read by the line image sensor 10, the cutting-out area processing section 12 shown in FIG. 1 recognizes, as readout data of the document, data in the area that is enclosed by a rectangular frame (indicated by a solid-line) in the image data IM and recognizes that area as a cutting-out area R. At the same time, the cutting-out area processing section 12 recognizes 16 divisional regions (0, 0) to (3, 3) (see FIG. 4) of the cutting-out area R as cutting-out blocks F.

In other words, the cutting-out area processing section 12 recognizes, as the cutting-out area R, the area containing the read-out data of the document and the cutting-out area R is a set of 16 cutting-out blocks F.

If a document being inclined is read as image data IM, as shown in FIG. 4 a cutting-out area R is recognized as being inclined from the main scanning direction of the image data IM. Cutting-out blocks (0, 0) to (3, 3) (indicated by solid lines) are recognized as 16 (4 (vertical)×4 (horizontal)) divisional blocks of the cutting-out area R.

The input image buffering section 13 shown in FIG. 1 is a storage section. The cutting-out area processing section 12 recognizes the document data as the cutting-out area R which is the set of cutting-out blocks F, and stores processing blocks E together containing the cutting-out area R in the input image buffering section 13.

The block data reading section 14 shown in FIG. 1 defines, as processing subject blocks G, processing blocks E each of which contains a cutting-out block F or part of a cutting-out block F among the processing blocks E (A, 0) to (D, 3), and sequentially reads, from the input image buffering section 13, in the main scanning direction, sets of processing subject blocks G corresponding to the respective groups of processing blocks E that are arranged in the auxiliary scanning direction. That is, the block data reading section 14 sequentially reads, as sets of processing subject blocks G, sets of processing blocks E of the respective groups from the input image buffering section 13 in order of a first group consisting of the processing blocks E (A, 0), (B, 0), (C, 0), and (D, 0), a second group consisting of the processing blocks E (A, 1), (B, 1), (C, 1), and (D, 1), and so forth.

The block rotating section 15 shown in FIG. 1 rotates, by a prescribed angle, each of processing subject blocks G that were recognized by the block data reading section 14 as containing a cutting-out block or part of a cutting-out block among the processing blocks E of each group, and stores resulting blocks in the rotated image buffering section 16. At this time, the positional relationships between the plural processing subject block G that are adjacent to each other in each group are maintained.

The rotated image buffering section 16 shown in FIG. 1 is a buffer having such a capacity as to be able to store three processing blocks E for each band of image data IM.

The pixel interpolating section 17 shown in FIG. 1 reads the pixel data of the rotation-corrected processing subject blocks G from the rotated image buffering section 16 and performs pixel interpolation on those pixel data.

The output image buffering section 18 shown in FIG. 1 temporarily stores image data IM (see FIG. 4) as subjected to the interpolation processing in the pixel interpolating section 17.

The output section 19 shown in FIG. 1, which is an interface for outputting the image data IM that has been subjected to the interpolation processing, reads the image data IM as subjected to the interpolation processing in the pixel interpolating section 17 from the output image buffering section 18 and outputs the image data IM to, for example, a personal computer (not shown) that is connected to the scanner.

An operation of the above-configured scanner according to the embodiment of the invention will be described below. The following description will be directed to a case that the scanner capable of reading an A3 document reads an A4 document in an inclined manner. As shown in FIG. 3, the management table correlates pieces of number information of the processing blocks E with pieces of head address information of the respective processing blocks E. It is also assumed that processing blocks E are such as to be obtained by dividing image data IM into four bands each having 64 pixels in the main scanning direction and dividing each band into four blocks each having 64 pixels in the auxiliary scanning direction.

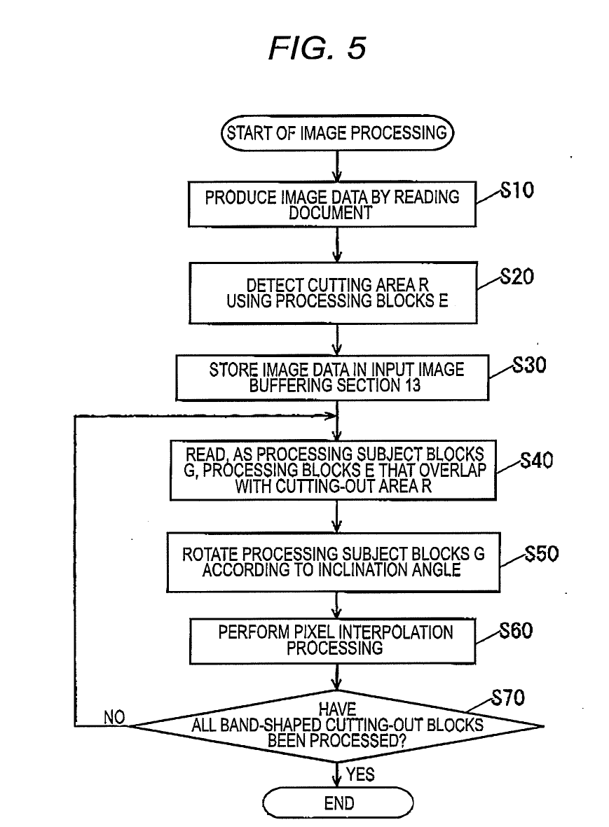

FIG. 5 is a flowchart for description of the operation of the image processing apparatus according to the embodiment of the invention.

As shown in FIG. 5, first, at step S10, the line image sensor 10 reads a reading subject document eight lines in the auxiliary scanning direction, for example, at a time and thereby converts the document into image data IM. When 64 lines of the document have been read in the auxiliary scanning direction, as shown in FIG. 2 the storage managing section 11 stores a head address of a processing block E (A, 0) in the management table as corresponding to block A of band 0. Likewise, head addresses of processing blocks (A, 1), (A, 2), and (A, 3) are separately stored in the management table as corresponding to block A of band 1, block A of band 2, and block A of band 3, respectively.

Then, likewise, head addresses of processing blocks E (B, 0) to (B, 3), (C, 0) to (C, 3), and (D, 0) to (D, 3) are stored sequentially in the management table.

At step S20, the cutting-out area processing section 12 recognizes an inclination, a width, and a height of the document, a document position, a document direction, etc. while reading the head addresses from the management table of the storage managing section 11 and detects a cutting-out area R (see FIG. 4). At step S30, the image data IM is stored in the input image buffering section 13 in units of a processing block E.

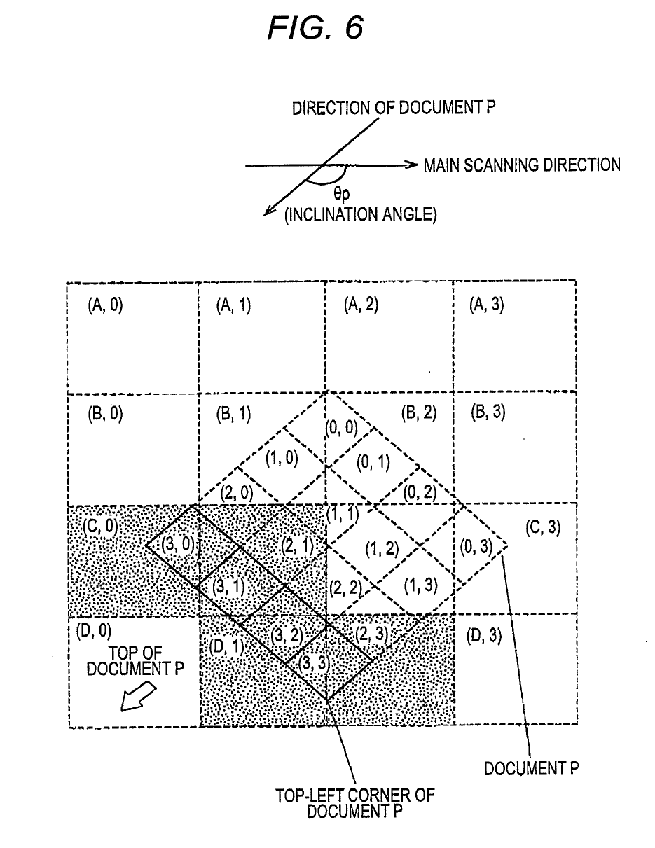

FIG. 6 shows processing subject blocks G in the management table of the image processing apparatus according to the embodiment of the invention.

As shown in FIG. 6, it is assumed that the cutting-out area processing section 12 detects that the inclination angle of a document P with respect to the main scanning direction is equal to θp. It is assumed that the inclination angle θp with respect to the main scanning direction is in such a range as to be larger than 180° and smaller than or equal to 225°. The cutting-out area processing section 12 sets the length of the shorter sides of each rectangular regions (band-shaped cutting-out blocks F′) that are cut out by the cutting-out area processing section 12 shorter than or equal to \sqrt{2} times the length of each side of each square processing block E.

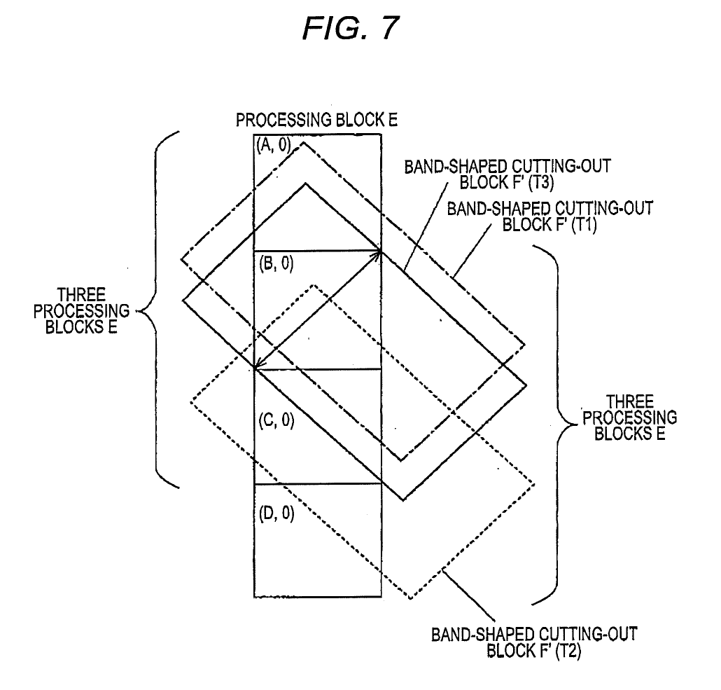

The size of cutting-out blocks F that is set by the cutting-out area processing section 12 will now be described with reference to FIG. 7.

FIG. 7 shows relationships between band-shaped cutting-out blocks F′ and processing subject blocks G in the image processing apparatus according to the embodiment of the invention. In the example of FIG. 7, as described above with reference to FIG. 2, the four square processing blocks E (A, 0) to (D, 0) are arranged in the vertical direction as band 0. Band-shaped cutting-out blocks F′ (T1)-(T3) of the cutting-out area R (see FIG. 4) overlap with the processing blocks E (A, 0) to (D, 0). The band-shaped cutting-out blocks F′ (T1)-(T3) are the same in outward form and inclination angle and different from each other only in position (i.e., they overlap with different sets of processing blocks E).

The band-shaped cutting-out block F′ (T1) which is indicated by a chain line overlaps with the top three processing blocks F (A, 0), (B, 0), and (C, 0) of the four processing blocks E which constitute band 0. The band-shaped cutting-out block F′ (T2) which is indicated by a broken line overlaps with the bottom three processing blocks F (B, 0), (C, 0), and (D, 0) of the same four processing blocks E. In this case, the area of overlap between a processing block E and a band-shaped cutting-out block F′ is largest when the two longer sides of the band-shaped cutting-out block F′ pass respective diagonal apices of the processing block E, that is, the two longer sides of the band-shaped cutting-out block F′ pass respective diagonal apices of the processing block E with the band-shaped cutting-out block F′ inclined with respect to the processing block E by 45°.

If the length of the shorter sides of each band-shaped cutting-out block F′ is set \sqrt{2} times the length of each side of each processing block E, the band-shaped cutting-out blocks F′ become rectangles whose width is equal to the diagonal length of each processing block E as is understood from the band-shaped cutting-out block F′ (T3) shown in FIG. 7.

Therefore, when the band-shaped cutting-out blocks F′ are inclined with respect to the processing blocks E by 45°, the band-shaped cutting-out blocks F′ (T1) and (T2) which are merely deviated in position from the band-shaped cutting-out block F′ (T3) overlap with the three processing blocks E in total, that is, the middle processing blocks E (B, 0) and (C, 0) and the one adjacent to the processing block E (A, 0) (located above) or (D, 0) (located below). Therefore, the cutting-out area R can be rotated using a minimum-capacity storage area if the rotated image buffering section 16 is provided with a storage capacity that corresponds to three processing blocks F for each band (see FIG. 2).

Returning to FIG. 5, at step S40, the block data reading section 14 shown in FIG. 1 reads, as processing subject blocks G, processing blocks E each of which overlaps with the cutting-out area R that was set by the cutting-out area processing section 12. In the embodiment, as shown in FIG. 6, processing subject blocks G are read out sequentially in order of ones for the cutting-out blocks F (3, 3) to (3, 0) . . . , ones for the cutting-out blocks F (0, 0) to (0, 3).

For example, as shown in FIG. 6, if the first band-shaped cutting-out block F′ consists of the four cutting-out blocks F (3, 3) to (3, 0), the processing block E (C, 0) of band 0, the processing blocks E (C, 1) and (D, 1) of band 1, and the processing block E (D, 2) of band 2 overlap with the band-shaped cutting-out block F′ (as shown in FIG. 2, each of bands 0-3 extends in the auxiliary scanning direction). The block rotating section 15 rotates each of those processing blocks E by a specified angle while maintaining the positional relationships between the read-out processing subject blocks G.

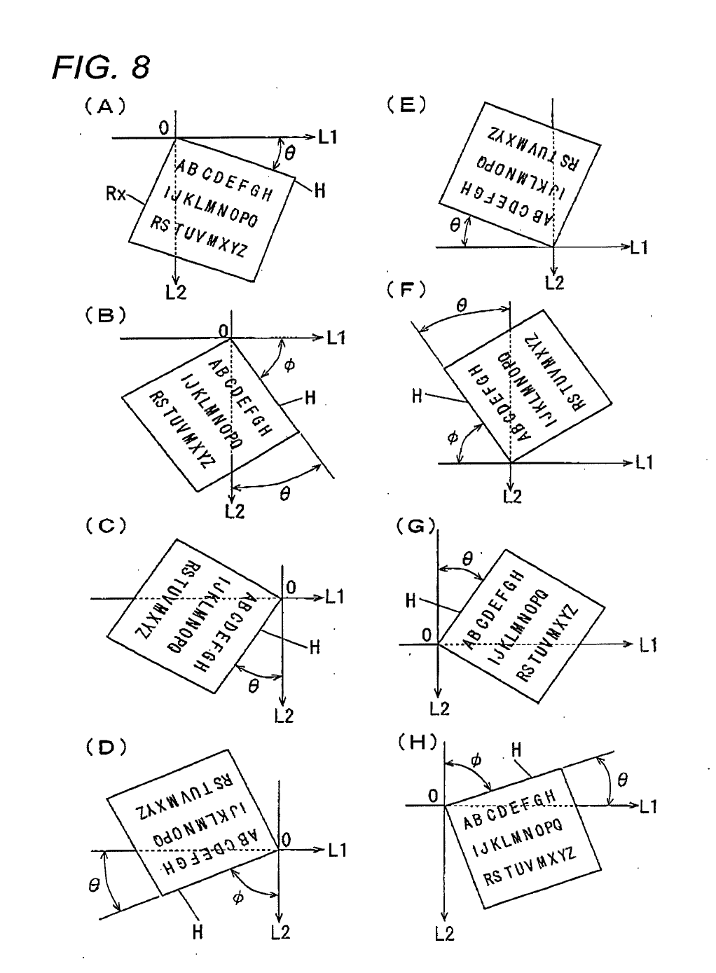

A method by which the block rotating section 15 shown in FIG. 1 rotates processing blocks E will be described below with reference to FIG. 8. FIG. 8 illustrates an operation of the block rotating section 15 of the image processing apparatus according to the embodiment of the invention. In FIG. 8, clockwise rotation is given the plus sign and counterclockwise rotation is given the minus sign.

The block rotating section 15 rotation-corrects a cutting-out area Rx of a document P by combining a positive rotation and a negative rotation so that the top side H of the cutting-out area Rx most efficiently coincides with a reference line L1 which extends in the main scanning direction from the center O which is the top-left apex of the cutting-out area Rx.

For example, if as shown in FIG. 8A the inclination angle of the top side H of the cutting-out area Rx with respect to the reference line L1 is smaller than or equal to 45°, since the angle that is formed by the top side H and the reference line L1 is θ, the block rotating section 15 rotates the cutting-out area Rx by −θ about the top-left apex of the cutting-out area Rx (center O; this rotation center will also be employed below consistently).

If as shown in FIG. 8B the inclination angle of the top side H of the cutting-out area Rx with respect to the reference line L1 is larger than 45° and smaller than or equal to 90°, the block rotating section 15 rotates the cutting-out area Rx by (90°−φ)=+θ and then by −90°.

If as shown in FIG. 8C the inclination angle of the top side H of the cutting-out area Rx with respect to the reference line L1 is larger than 90° and smaller than or equal to 135°, the block rotating section 15 rotates the cutting-out area Rx by (−90°−θ), where θ is the inclination angle of the top side H of the cutting-out area Rx with respect to a reference line L2.

In this embodiment, the reference line L2 extends perpendicularly to the reference line L1 (i.e., extends in the auxiliary scanning direction) and intersects the reference line L1 at the center O. However, the invention is not limited to such a case.

If as shown in FIG. 8D the inclination angle of the top side H of the cutting-out area Rx with respect to the reference line L1 is larger than 135° and smaller than or equal to 180°, the block rotating section 15 rotates the cutting-out area Rx by (90°−φ)=+θ and then by −180°.

If as shown in FIG. 8E the inclination angle of the top side H of the cutting-out area Rx with respect to the reference line L1 is larger than 180° and smaller than or equal to 225°, the block rotating section 15 rotates the cutting-out area Rx by (−180°−θ).

If as shown in FIG. 8F the inclination angle of the top side H of the cutting-out area Rx with respect to the reference line L1 is larger than 225° and smaller than or equal to 270°, the block rotating section 15 rotates the cutting-out area Rx by (90°−φ)=+θ and then by −270° or +90°.

If as shown in FIG. 8G the inclination angle of the top side H of the cutting-out area Rx with respect to the reference line L1 is larger than 270° and smaller than or equal to 315°, the block rotating section 15 rotates the cutting-out area Rx by (−θ+90°) or (−θ−270°).

If as shown in FIG. 8H the inclination angle of the top side H of the cutting-out area Rx with respect to the reference line L1 is larger than 315° and smaller than or equal to 360°, the block rotating section 15 rotates the cutting-out area Rx by (90°−φ)=+θ.

As described above, in each of the first to fourth quadrants which are defined by the reference lines L1 and L2, the block rotating section 15 rotates processing blocks E by an arbitrary angle from 0° to 360° in such a manner that first a rotation that is smaller than or equal to 45° is performed so that the top side H of the cutting-out area Rx coincides with the reference line L1 or L2 and then a rotation of 90°, 180°, or 270° is performed if necessary.

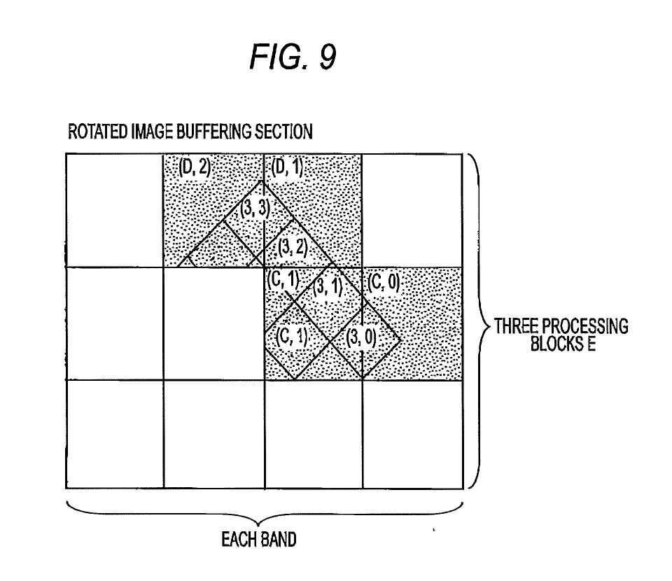

FIG. 9 illustrates an operation of the rotated image buffering section 16 of the image processing apparatus according to the embodiment of the invention. FIG. 9 is an upside-down version of FIG. 6. As shown in FIG. 9, the block rotating section 15 shown in FIG. 1 rotates each of the processing blocks E (C, 0), (C, 1), (D, 1), and (D, 2) (i.e., processing subject blocks G) by −180° and then by (180°−θp) while maintaining the positional relationships between them.

Since the inclination angle θp with respect to the main scanning direction is larger than 180° and smaller than or equal to 225°, the processing subject blocks G are rotated by −180° and stored in the rotated image buffering section 16. Then, the block rotating section 15 reads the processing subject blocks G from the rotated image buffering section 16 and rotates them by (180°−θp) which remains after the rotation of −180° (step S50).

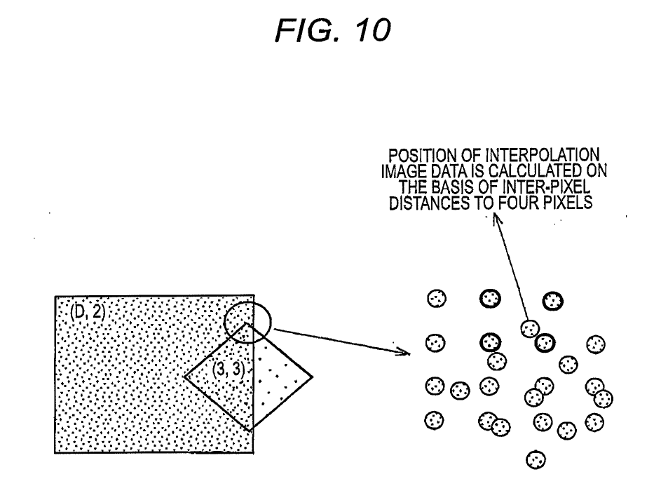

FIG. 10 illustrates pixel interpolation processing of the image processing apparatus according to the embodiment of the invention. Upon completion of the rotation for the first band-shaped cutting-out block F′, the pixel interpolating section 17 reads the processing blocks E (C, 0), (C, 1), (D, 1), and (D, 2) from the rotated image buffering section 16. For example, as shown in FIG. 10, in the processing block E (D, 2), pixels are arranged approximately at regular intervals in each of the main scanning direction and the auxiliary scanning direction. If part of the cutting-out block F (3, 3) exists in the processing block E (D, 2), pixels of the cutting-out block F (3, 3) are mixed with the pixels of the processing block E (D, 2) as shown in the right-hand part of FIG. 10 which is an enlarged version of a circled part of the left-hand part.

The pixel interpolating section 17 detects coordinates of the apex pixel of the cutting-out block F (3, 3), calculates inter-pixel distances between the apex pixel and the four pixels (enclosed by thick circles) of the processing block E (D, 2) that surround the apex pixel, and calculates a position of interpolation image data on the basis of the calculated inter-pixel distances. Image data IM produced by the pixel interpolating section 17 through such interpolation is stored in the output image buffering section 18 (step S60).

At step S70, the block data reading section 14 judges whether or not all of the band-shaped cutting-out blocks F′ have been processed. If not all of the band-shaped cutting-out blocks F′ have been processed yet, the block data reading section 14 reads out processing blocks E that overlap with the band-shaped cutting-out block F′ that is next to the just-processed band-shaped cutting-out blocks F′.

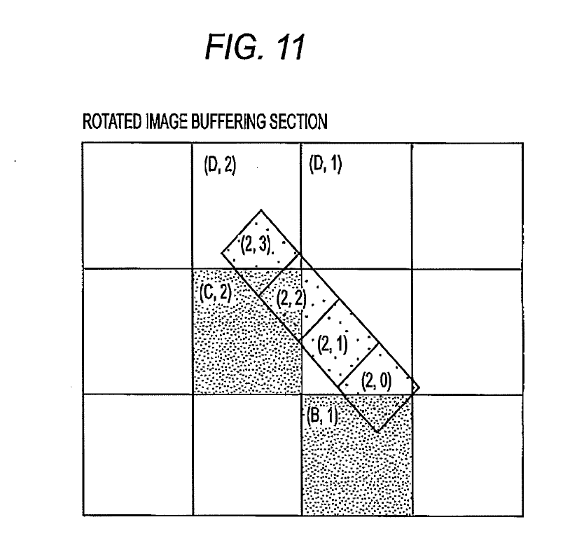

FIG. 11 shows a subsequent operation of the rotated image buffering section 16 of the image processing apparatus according to the embodiment of the invention. As shown in FIG. 11, the ban-shaped cutting-out block F′ to be processed consists of the four cutting-out blocks F (2, 3) to (2, 0), which are processed according to the same procedure as described above.

When all of the cuffing-out blocks F that constitute the cutting-out area R have been subjected to the rotation processing in the above-described manner, the output section 19 reads resulting image data IM from the output image buffering section 18 and outputs it to the personal computer that is connected to the scanner.

As described above, in the scanner according to the embodiment, to cut out and rotate a rectangular area that is inclined with respect to the area of image data IM by a certain angle, at most three processing blocks E that overlap with each band-shaped cutting-out block F′ are read out as processing subject blocks G for each band of the image data IM. As a result, the rotation processing can be performed by processing a smallest amount of data.

It suffices that the rotated image buffering section 16 for storing processing blocks E to perform rotation has a capacity corresponding to three processing blocks E for each band of image data IM. Therefore, the necessary buffer capacity can be minimized.

Furthermore, since a cutting-out area is formed by cutting out blocks F which are arranged in the vertical direction and the horizontal direction and processing is performed in units of a cutting-out block F, data rotation can be performed without increasing the capacity of the rotated image buffering section 16 even in the case of rotating a wide cutting-out area.

Capable of reducing a memory capacity that is necessary in rotating image data by an arbitrary angle, the invention can suitably applied to an image processing apparatus and its image processing method for reading a document image with an image sensor and storing resulting image data in a storage section.

This application claims the benefit of Japanese Patent application No. 2009-084601 filed on Mar. 31, 2000, the entire contents of which are incorporated herein by reference.

1. An image processing apparatus, comprising:
a storage section for storing image data;
a storage managing section for managing the image data in the form of plural processing blocks that are arranged in a vertical direction and a horizontal direction, and storing at least part of the processing blocks in the storage section in such a manner that each processing block is accessible;
a block data reading section for reading, as processing subject blocks, processing blocks that overlap with a rectangular area inclined with respect to the image data by a certain angle and in which at most three processing blocks are arranged in a reference direction which is a vertical direction or a horizontal direction, from the storage section for each band of processing blocks arranged in the reference direction;
a rotated image buffering section for storing the read-out processing subject blocks, the rotated image buffering section having a capacity corresponding to three processing blocks for each band of processing blocks arranged in the reference direction; and
a block rotating section for rotating the processing subject blocks that are read out by the block data reading section by a specified angle while maintaining positional relationships between the processing subject blocks, and storing rotated processing subject blocks in the rotated image buffering section.

2. The image processing apparatus according to claim 1, further comprising:
a cutting-out area processing section for dividing the rectangular area into cutting-out blocks that are arranged in two orthogonal directions when a width of the rectangular area is greater than a prescribed value, the image processing apparatus;
wherein the block data reading section sequentially reads sets of processing subject blocks that overlap with respective band-shaped cutting-out blocks each extending in one of the two orthogonal directions.

3. The image processing apparatus according to claim 2, wherein the cutting-out area processing section sets a length of shorter sides of each of the band-shaped cutting-out blocks shorter than or equal to √2 times a length of each side of each of the processing blocks which are square.

4. The image processing apparatus according to claim 1, wherein the block rotating section performs a combination of a rotation of 90°, 180°, or 270° and a rotation of an angle that is larger than 0° and smaller than or equal to 45° on the rectangular area when an angle formed by a longitudinal direction of the rectangular area and the reference direction which is an inclination angle of the rectangular area is larger than 45°.

5. An image processing method, comprising:
a storage managing step of managing image data in the form of plural processing blocks that are arranged in a vertical direction and a horizontal direction, and storing at least part of the processing blocks in storage section in such a manner that each processing block is accessible;
a block data reading step of reading, as processing subject blocks, processing blocks that overlap with a rectangular area inclined with respect to the image data by a certain angle and in which at most three processing blocks are arranged in a reference direction which is a vertical direction or a horizontal direction, from the storage section for each band of processing blocks arranged in the reference direction; and
a block rotating step of rotating the read-out processing subject blocks by a specified angle while maintaining positional relationships between the processing subject blocks, and storing rotated processing subject blocks in a rotated image buffering section for storing the read-out processing subject blocks which has a capacity corresponding to three processing blocks for each band of processing blocks arranged in the reference direction.
